(19) United States
(12) Patent Application Publication
(10) Pub. No.: US 2026/0092178 A1
(43) Pub. Date: Apr. 2, 2026

(54) POLYCARBONATE-BASED COMPOSITIONS AND LASER-WELDED ARTICLES INCLUDING SAME

(71) Applicant: AVIENT CORPORATION, Avon Lake, OH (US)

(72) Inventors: Edward ZOU, Shanghai (CN); Yagang CHEN, Shanghai (CN); Lijun XU, Shanghai (CN)

(21) Appl. No.: 19/112,027

(22) PCT Filed: Sep. 15, 2022
(86) PCT No.: PCT/CN2022/118992

§ 371 Date: Mar. 14, 2025

(51) Int. Cl. C08L 83/10; B29C 65/16; B29K 69/00; B29K 96/04; C08K 5/103; C08K 5/5399

(52) U.S. Cl. CPC C08L 83/10; B29C 65/1635; C08K 5/103; C08K 5/5399; B29K 2069/00; B29K 2096/04; B29K 2995/0012; B29K 2995/0016; B29K 2995/0027; B29K 2995/0089; C08L 2205/03; C08L 2207/53

(57) ABSTRACT

Embodiments of the present disclosure are directed to polycarbonate-based compositions comprising, based on a total weight of the polycarbonate-based composition, 15 wt % to 35 wt % of polycarbonate, 50 wt % to 75 wt % of polysiloxane-polycarbonate copolymer, 7 wt % to 15 wt % of a flame retardant, and greater than 0.5 wt % to 2 wt % of an impact modifier.

### TECHNICAL FIELD

Embodiments of the present disclosure are generally related to polycarbonate-based compositions, and are specifically related to polycarbonate-based compositions having a sufficient thin-wall flammability rating, melt flow rate, low temperature impact strength, and transmission.

### BACKGROUND

Laser welding provides advantages in design capability and scalability (e.g., miniaturization), cycle time, and cost efficiency over other bonding methods, such as ultrasonic welding and adhesives. Polycarbonate may have desirable properties for use in laser welding, such as transmission. However, it may be difficult to obtain other desirable properties, such as thin-wall flame retardancy, melt flow rate, and low temperature impact strength, while maintaining transmission.

Accordingly, a continuous need exists for polycarbonate-based compositions having sufficient thin-wall flammability rating, melt flow rate, low temperature impact strength, and transmission.

### SUMMARY

Embodiments of the present disclosure are directed to polycarbonate-based compositions comprising polycarbonate, polysiloxane-polycarbonate copolymer, a flame retardant, and an impact modifier, which have sufficient thin-wall flammability rating, melt flow rate, low temperature impact strength, and transmission.

According to one embodiment, a polycarbonate-based composition is provided. The polycarbonate-based composition comprises, based on a total weight of the polycarbonate-based composition, 15 wt % to 35 wt % of polycarbonate, 50 wt % to 75 wt % of polysiloxane-polycarbonate copolymer, 7 wt % to 15 wt % of a flame retardant, and greater than 0.5 wt % to 2 wt % of an impact modifier.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DRAWINGS

FIG. 1 is a flow chart of a method of preparing a laser-welded article, according to one or more embodiments shown and described herein;

FIG. 2 schematically depicts a step of the method of FIG. 1; and

FIG. 3 schematically depicts a laser-welded article, according to one or more embodiments shown and described herein.

### DETAILED DESCRIPTION

Reference will now be made in detail to various embodiments of polycarbonate-based compositions, specifically polycarbonate-based compositions comprising, based on a total weight of the polycarbonate-based composition, 15 wt % to 35 wt % of polycarbonate, 50 wt % to 75 wt % of polysiloxane-polycarbonate copolymer, 7 wt % to 15 wt % of a flame retardant, and greater than 0.5 wt % to 2 wt % of an impact modifier.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “thin-wall flammability rating,” as described herein, refers to the comparative burning characteristics of a material having article dimensions of 127 mm×12.7 mm×0.6 mm measured in accordance with UL 94 Standard Test Procedures. The term “sufficient flammability rating,” as used herein, refers to a UL 94 Standard Test Procedures flammability classification rating of V-0.

The term “melt flow rate,” as described herein, refers to the ability of a material's melt to flow under pressure, as measured according to ASTM D1238-20 at the given temperature and given weight. The term “sufficient melt flow rate,” as used herein, refers to a melt flow rate greater than or equal to 15.0 g/10 min, as measured according ASTM D1238-20 at a temperature of 300° C. and a load of 1.2 kg

The term “low temperature impact strength,” as described herein, refers to the kinetic energy needed to initiate fracture and continue the fracture until an article formed from the polycarbonate-based composition described herein is broken, as measured according to ASTM D256-10 at −25° C. and 5.5 J and at article dimensions of 63.5 mm×12.7 mm×3.2 mm. The term “sufficient low temperature impact strength,” as used herein, refers to a low temperature Notched Izod impact strength greater than or equal to 500 J/m, as measured according to ASTM D256-10 at −25° C. and 5.5 J and at article dimensions of 63.5 mm×12.7 mm×3.2 mm.

The term “transmission,” as described herein, is measured using a thermoelectric power measurement at a wavelength of 800 nm to 1100 nm and an article thickness of 0.6 mm. In particular, a beam divider is used to divide a reference beam at an angle of 90°. The reference beam impacts the reference sensor. The portion of the original beam passing through the beam divider provides the measurement beam. An injection-molded test sheet having dimensions of 127 mm×12.7 mm×0.6 mm with edge gating is positioned on the measurement sensor. A measurement is made in the middle of the sheet. Signals from the reference sensor and the measurement sensor are recorded simultaneously. Laser transmission is obtained according to the following formula:

Laser transmission=(signal (measurement sensor)/signal (reference sensor))×100

The term “sufficient transmission,” as used herein, refers to a transmission greater than or equal to 55%, as measured according to the thermoelectric power measurement described herein at a wavelength of 800 nm to 1100 nm and an article thickness of 0.6 mm.

The term “tensile strength,” as described herein, refers to the maximum stress that a material can withstand while stretching before it begins to change shape permanently, as measured according to ASTM D638 at 23° C. and a rate of strain of 0.85 mm/s.

The term “tensile modulus,” as described herein, refers the ratio of the stress along an axis over the strain along that axis, as measured according to ASTM D638 at 23° C. and a rate of strain of 0.085 mm/s.

The term “D50 particle size,” as used herein, refers to the median particle size.

As discussed hereinabove, laser welding provides advantages in design capability and scalability (e.g., miniaturization), cycle time, and cost efficiency over other bonding methods, such as ultrasonic welding and adhesives. Polycarbonate may have desirable properties for use in laser welding, such as transmission. Polycarbonate-based materials may also be preferred in certain applications, such as electronic housing (e.g., batteries), personal care, consumer and industrial electronics, devices, and healthcare, due to their mechanical properties, such as tensile strength and modulus. However, it may be difficult to obtain other desirable properties, such as thin-wall flame retardancy, melt flow rate, and low temperature impact strength, while maintaining transmission.

Disclosed herein are polycarbonate-based compositions, which mitigate the aforementioned problems. Specifically, the polycarbonate-based compositions disclosed herein comprise, based on a total weight of the polycarbonate-based composition, 15 wt % to 35 wt % of polycarbonate, 50 wt % to 75 wt % of polysiloxane-polycarbonate copolymer, 7 wt % to 15 wt % of a flame retardant, and greater than 0.5 wt % to 2 wt % of an impact modifier, which results in a polycarbonate-based composition having a sufficient thin-wall flammability rating, melt flow rate, low temperature impact strength, and transmission. In particular, the combination of polycarbonate, polysiloxane-polycarbonate copolymer, the flame retardant, and the impact modifier, present in the given amounts, results in these sufficient properties.

The polycarbonate-based compositions disclosed herein may generally be described as comprising polycarbonate, polysiloxane-polycarbonate copolymer, a flame retardant, and an impact modifier.

### Polycarbonate

The polycarbonate-based composition may include a minimum amount of polycarbonate (e.g., greater than or equal to 15 wt %) to ensure the polycarbonate-based composition achieves a sufficient transmission. The amount of polycarbonate may be limited (e.g., less than or equal to 35 wt %) to ensure other components may be included in certain amounts to achieve sufficient thin-wall flammability rating, melt flow rate, and low temperature impact strength. Accordingly, in embodiments, the polycarbonate-based composition may comprise, based on a total weight of the polycarbonate-based composition, 15 wt % to 35 wt % of polycarbonate. In embodiments, the amount of the polycarbonate in the polycarbonate-based composition may be, based on a total weight of the polycarbonate-based composition, greater than or equal to 15 wt %, greater than or equal to 17 wt %, greater than or equal to 19 wt %, or even greater than or equal to 21 wt %. In embodiments, the amount of the polycarbonate in the polycarbonate-based composition may be, based on a total weight of the polycarbonate-based composition, less than or equal to 35 wt %, less than or equal to 33 wt %, less than or equal to 30 wt %, less than or equal to 27 wt %, or even less than or equal to 25 wt %. In embodiments, the amount of the polycarbonate in the polycarbonate-based composition may be, based on a total weight of the polycarbonate-based composition, from 15 wt % to 35 wt %, from 15 wt % to 33 wt %, from 15 wt % to 30 wt %, from 15 wt % to 27 wt %, from 15 wt % to 25 wt %, from 17 wt % to 35 wt %, from 17 wt % to 33 wt %, from 17 wt % to 30 wt %, from 17 wt % to 27 wt %, from 17 wt % to 25 wt %, from 19 wt % to 35 wt %, from 19 wt % to 33 wt %, from 19 wt % to 30 wt %, from 19 wt % to 27 wt %, from 19 wt % to 25 wt %, from 21 wt % to 35 wt %, from 21 wt % to 33 wt %, from 21 wt % to 30 wt %, from 21 wt % to 27 wt %, or even from 21 wt % to 25 wt %, or any and all sub-ranges formed from any of these endpoints.

As described herein, the amount of polycarbonate in the polycarbonate-based composition is not inclusive of the polysiloxane-polycarbonate copolymer.

In embodiments, the polycarbonate may have a weight-average molecular weight from about 20,000 g/mol to about 30,000 g/mol to ensure a balance between melt flow rate and low temperature impact strength. If the weight-average molecular weight of the polycarbonate is too high (e.g., greater than about 30,000 g/mol), then the melt flow rate may decrease. If the weight-average molecular weight of the polycarbonate is too low (e.g., less than or equal to about 20,000 g/mol), then the low temperature impact strength may decrease. In embodiments, the polycarbonate may have a weight-average molecular weight greater than or equal to about 20,000 g/mol, greater than or equal to about 22,000 g/mol, or even greater than or equal to about 24,000 g/mol. In embodiments, the polycarbonate may have a weight-average molecular weight less than or equal to about 30,000 g/mol, less than or equal to about 28,000 g/mol, or even less than or equal to about 26,000 g/mol. In embodiments, the polycarbonate may have a weight-average molecular weight from about 20,000 g/mol to about 30,000 g/mol, from about 20,000 g/mol to about 28,000 g/mol, from about 20,000 g/mol to about 26,000 g/mol, from about 22,000 g/mol to about 30,000 g/mol, from about 22,000 g/mol to about 28,000 g/mol, from about 22,000 g/mol to about 26,000 g/mol, from about 24,000 g/mol to about 30,000 g/mol, from about 24,000 g/mol to about 28,000 g/mol, or even from about 24,000 g/mol to about 26,000 g/mol, or any and all sub-ranges formed from any of these endpoints.

In embodiments, the polycarbonate may have a melt flow rate greater than or equal to 5 g/10 min or even greater than or equal to 10 g/10 min. In embodiments, the polycarbonate may have a melt flow rate less than or equal to 30 g/10 min, less than or equal to 25 g/10 min, or even less than or equal to 20 g/10 min. In embodiments, the polycarbonate may have a melt flow rate from 5 g/10 min to 30 g/10 min, from 5 g/10 min to 25 g/10 min, from 5 g/10 min to 20 g/10 min, from 10 g/10 min to 30 g/10 min, from 10 g/10 min to 25 g/10 min, or even from 10 g/10 min to 20 g/10 min, or any and all sub-ranges formed from any of these endpoints.

Suitable commercial embodiments of the polycarbonate component are available under the MAKROLON brand from Covestro, such as grades 2805 and 2405.

### Polysiloxane-polycarbonate Copolymer

In embodiments, the polycarbonate-based composition may comprise, based on a total weight of the polycarbonate-based composition, 50 wt % to 75 wt % of polysiloxane-polycarbonate copolymer to ensure the polycarbonate-based composition achieves a sufficient melt flow rate. In embodiments, the amount of the polysiloxane-polycarbonate copolymer in the polycarbonate-based composition may be, based on a total weight of the polycarbonate-based composition, greater than or equal to 50 wt %, greater than or equal to 53 wt %, greater than or equal to 55 wt %, greater than or equal to 57 wt %, greater than or equal to 60 wt %, or even greater than or equal to 63 wt %. In embodiments, the amount of the polysiloxane-polycarbonate copolymer in the polycarbonate-based composition may be, based on a total weight of the polycarbonate-based composition, less than or equal to 75 wt %, less than or equal to 73 wt %, less than or equal to 70 wt %, or even less than or equal to 67 wt %. In embodiments, the amount of the polysiloxane-polycarbonate copolymer in the polycarbonate-based composition may be, based on a total weight of the polycarbonate-based composition, from 50 wt % to 75 wt %, from 50 wt % to 73 wt %, from 50 wt % to 70 wt %, from 50 wt % to 67 wt %, from 53 wt % to 75 wt %, from 53 wt % to 73 wt %, from 53 wt % to 70 wt %, from 53 wt % to 67 wt %, from 55 wt % to 75 wt %, from 55 wt % to 73 wt %, from 55 wt % to 70 wt %, from 55 wt % to 67 wt %, from 57 wt % to 75 wt %, from 57 wt % to 73 wt %, from 57 wt % to 70 wt %, from 57 wt % to 67 wt %, from 60 wt % to 75 wt %, from 60 wt % to 73 wt %, from 60 wt % to 70 wt %, from 60 wt % to 67 wt %, from 63 wt % to 75 wt %, from 63 wt % to 73 wt %, from 63 wt % to 70 wt %, or even from 63 wt % to 67 wt %, or any and all sub-ranges formed from any of these endpoints.

In embodiments, the polysiloxane-polycarbonate copolymer may comprise a weight-average molecular weight from about 20,000 g/mol to about 40,000 g/mol. In embodiments, the polysiloxane-polycarbonate copolymer may comprise a weight-average molecular weight greater than or equal to about 20,000 g/mol, greater than or equal to about 23,000 g/mol, greater than or equal to about 25,000 g/mol, or even greater than or equal to about 27,000 g/mol. In embodiments, the polysiloxane-polycarbonate copolymer may comprise a weight-average molecular weight less than or equal to about 40,000 g/mol, less than or equal to about 37,000 g/mol, less than or equal to about 35,000 g/mol, or even less than or equal to about 33,000 g/mol. In embodiments, the polysiloxane-polycarbonate copolymer may comprise a weight-average molecular weight from about 20,000 g/mol to about 40,000 g/mol, from about 20,000 g/mol to about 37,000 g/mol, from about 20,000 g/mol to about 35,000 g/mol, from about 20,000 g/mol to about 33,000 g/mol, from about 23,000 g/mol to about 40,000 g/mol, from about 23,000 g/mol to about 37,000 g/mol, from about 23,000 g/mol to about 35,000 g/mol, from about 23,000 g/mol to about 33,000 g/mol, from about 25,000 g/mol to about 40,000 g/mol, from about 25,000 g/mol to about 37,000 g/mol, from about 25,000 g/mol to about 35,000 g/mol, from about 25,000 g/mol to about 33,000 g/mol, from about 27,000 g/mol to about 40,000 g/mol, from about 27,000 g/mol to about 37,000 g/mol, from about 27,000 g/mol to about 35,000 g/mol, or even from about 27,000 g/mol to about 33,000 g/mol, or any and all sub-ranges formed from any of these endpoints.

Suitable commercial embodiments of the polysiloxane-polycarbonate component are available under the TRIREX brand from Samyang, such as grade ST6-3022PJ(1).

### Flame Retardant

The polycarbonate-based composition may include a minimum amount of a flame retardant (e.g., greater than or equal to 7 wt %) to ensure that the polycarbonate-based composition achieves a sufficient thin-wall flammability rating. The amount of flame retardant may be limited (e.g., less than or equal to 15 wt %) to ensure the polycarbonate-based composition achieves a sufficient low temperature impact strength. Accordingly, in embodiments, the polycarbonate-based composition may comprise, based on a total weight of the polycarbonate-based composition, 7 wt % to 15 wt % of a flame retardant. In embodiments, the amount of the flame retardant in the polycarbonate-based composition may be, based on a total weight of the polycarbonate-based composition, greater than or equal to 7 wt %, greater than or equal to 8 wt %, or even greater than or equal to 9 wt %. In embodiments, the amount of the flame retardant in the polycarbonate-based composition may be, based on a total weight of the polycarbonate-based composition, less than or equal to 15 wt %, less than or equal to 14 wt %, less than or equal to 13 wt %, or even less than or equal to 12 wt %. In embodiments, the amount of the flame retardant in the polycarbonate-based composition may be, based on a total weight of the polycarbonate-based composition, from 7 wt % to 15 wt %, from 7 wt % to 14 wt %, from 7 wt % to 13 wt %, from 7 wt % to 12 wt %, from 8 wt % to 15 wt %, from 8 wt % to 14 wt %, from 8 wt % to 13 wt %, from 8 wt % to 12 wt %, from 9 wt % to 15 wt %, from 9 wt % to 14 wt %, from 9 wt % to 13 wt %, or even from 9 wt % to 12 wt %, or any and all sub-ranges formed from any of these endpoints.

In embodiments, the flame retardant may be a cyclic phenoxyphosphazene. While not wishing to be bound by theory, it is believed that there is a synergistic effect between phosphorus and nitrogen of the cyclic phenoxyphosphazene, leading to a more efficient flame retardant. In particular, the flame retardancy mechanism of cyclic phenoxyphosphazene is due to the coexistence of the flame retardant in a condensed phase and a gas phase. In the condensed phase, polyphosphate and metaphosphate are produced by thermal decomposition of cyclic phenoxyphosphazene at a high temperature, which char and cover the surface of a polymer included in the composition, thereby preventing further decomposition of the polymer. This prevents further combustion of the polymer. At the same time, in the gas phase, the combustion also produces phosphooxygen free radicals and inflammable gases (e.g., PO⁻0 and NH₃), which may terminate the free radical chain reaction and dilute the concentration of flammable gases. Accordingly, cyclic phenoxyphosphazene is believed to be a high-efficient flame retardant for polycarbonate-based compositions, which may be effective in lower amounts than other flame retardants, thereby leading to reduced effects on other properties of the polycarbonate-based composition.

Suitable commercial embodiments of the flame retardant are available under from Weihai Jinwei ChemIndustry Co., Ltd., such as cyclic phenoxyphosphazene grade HPCTP; from Otsuka, such as cyclic phenozyphosphazene grades SPB-100, SPE-100, and SPS 100; from Lanvin Chemical Co., Ltd., such cyclic phenozyphosphazene grade LY202; and from Sushimi Pharmaceutical Co., Ltd., such as cyclic phenozyphosphazene grade FP-110.

### Impact Modifier

The polycarbonate-based composition may comprise a minimum amount of an impact modifier (e.g., greater than 0.5 wt %) to ensure that the polycarbonate-based composition achieves a sufficient low temperature impact strength. The amount of the impact modifier may be limited (e.g., less than or equal to 2 wt %) to ensure that the polycarbonate-based composition achieves a sufficient transmission. Accordingly, in embodiments, the polycarbonate-based composition may comprise, based on a total weight of the polycarbonate-based composition, greater than 0.5 wt % to 2 wt % of an impact modifier. In embodiments, the amount of the impact modifier in the polycarbonate-based composition may be, based on a total weight of the polycarbonate-based composition, greater than 0.5 wt %, greater than or equal to 0.6 wt %, greater than or equal to 0.7 wt %, greater than or equal to 0.8 wt %, greater than or equal to 0.9 wt %, or even greater than or equal to 1 wt %. In embodiments, the amount of the impact modifier in the polycarbonate-based composition may be, based on a total weight of the polycarbonate-based composition, less than or equal to 2 wt %, less than or equal to 1.9 wt %, less than or equal to 1.8 wt %, less than or equal to 1.7 wt %, less than or equal to 1.6 wt %, or even less than or equal to 1.5 wt %. In embodiments, the amount of the impact modifier in the polycarbonate-based composition may be, based on a total weight of the polycarbonate-based composition, from greater than 0.5 wt % to 2 wt %, from greater than 0.5 wt % to 1.9 wt %, from greater than 0.5 wt % to 1.8 wt %, from greater than 0.5 wt % to 1.7 wt %, from greater than 0.5 wt % to 1.6 wt %, from greater than 0.5 wt % to 1.5 wt %, from 0.6 wt % to 2 wt %, from 0.6 wt % to 1.9 wt %, from 0.6 wt % to 1.8 wt %, from 0.6 wt % to 1.7 wt %, from 0.6 wt % to 1.6 wt %, from 0.6 wt % to 1.5 wt %, from 0.7 wt % to 2 wt %, from 0.7 wt % to 1.9 wt %, from 0.7 wt % to 1.8 wt %, from 0.7 wt % to 1.7 wt %, from 0.7 wt % to 1.6 wt %, from 0.7 wt % to 1.5 wt %, from 0.8 wt % to 2 wt %, from 0.8 wt % to 1.9 wt %, from 0.8 wt % to 1.8 wt %, from 0.8 wt % to 1.7 wt %, from 0.8 wt % to 1.6 wt %, from 0.8 wt % to 1.5 wt %, from 0.9 wt % to 2 wt %, from 0.9 wt % to 1.9 wt %, from 0.9 wt % to 1.8 wt %, from 0.9 wt % to 1.7 wt %, from 0.9 wt % to 1.6 wt %, from 0.9 wt % to 1.5 wt %, from 1 wt % to 2 wt %, from 1 wt % to 1.9 wt %, from 1 wt % to 1.8 wt %, from 1 wt % to 1.7 wt %, from 1 wt % to 1.6 wt %, or even from 1 wt % to 1.5 wt %, or any and all sub-ranges formed from any of these endpoints.

In embodiments, the impact modifier may be a core-shell particle. In embodiments, the impact modifier may be a silicone-acrylic rubber impact modifier. For example, in embodiments, the core may comprise silicone-acrylate rubber and the shell may comprise methyl methacrylate. While not wishing to be bound by theory, it is believed that a silicone-acrylic rubber impact modifier may have more of a synergistic effect with the flame retardant as compared to other impact modifiers, leading to a sufficient thin-wall flammability rating.

In embodiments, the impact modifier may be a core-shell particle having a D50 particle size from 200 nm to 800 nm to ensure the polycarbonate-based composition achieves a sufficient transmission. In embodiments, the core-shell particle may have a D50 particle size greater than or equal to 200 nm, greater than or equal to 250 nm, greater than or equal to 300 nm, greater than or equal to 350 nm, greater than or equal to 400 nm, or even greater than or equal to 450 nm. In embodiments, the core-shell particle may have a D50 particle size less than or equal to 800 nm, less than or equal to 750 nm, less than or equal to 700 nm, less than or equal to 650 nm, less than or equal to 600 nm, or even less than or equal to 550 nm. In embodiments, the core-shell particle may have a D50 particle size from 200 nm to 800 nm, from 200 nm to 750 nm, from 200 nm to 700 nm, from 200 nm to 650 nm, from 200 nm to 600 nm, from 200 nm to 550 nm, from 250 nm to 800 nm, from 250 nm to 750 nm, from 250 nm to 700 nm, from 250 nm to 650 nm, from 250 nm to 600 nm, from 250 nm to 550 nm, from 300 nm to 800 nm, from 300 nm to 750 nm, from 300 nm to 700 nm, from 300 nm to 650 nm, from 300 nm to 600 nm, from 300 nm to 550 nm, from 350 nm to 800 nm, from 350 nm to 750 nm, from 350 nm to 700 nm, from 350 nm to 650 nm, from 350 nm to 600 nm, from 350 nm to 550 nm, from 400 nm to 800 nm, from 400 nm to 750 nm, from 400 nm to 700 nm, from 400 nm to 650 nm, from 400 nm to 600 nm, from 400 nm to 550 nm, from 450 nm to 800 nm, from 450 nm to 750 nm, from 450 nm to 700 nm, from 450 nm to 650 nm, from 450 nm to 600 nm, or even from 450 nm to 550 nm, or any and all sub-ranges formed from any of these endpoints.

Suitable commercial embodiments of the impact modifier are available under the METABLEN brand from Mitsubishi Chemical Group, such as silicone-acrylic grade S 2030.

### Polycarbonate-based Composition

As described herein, the polycarbonate-based compositions may have a combination of polycarbonate, polysiloxane-polycarbonate copolymer, the flame retardant, and the impact modifier, present in given amounts, resulting in sufficient thin-wall flammability rating, melt flow rate, low temperature impact strength, and transmission.

In embodiments, the polycarbonate-based composition may be in the form of an article, the article having at least one dimension from 0.4 mm to 0.8 mm. In embodiments, the polycarbonate-based composition may be in the form of an article, the article having at least one dimension less than or equal to 0.6 mm. In embodiments, the article may have at least one dimension less than or equal to 0.8 mm, less than or equal to 0.7 mm, or even less than or equal to 0.6 mm. In embodiments, the article may have at least one dimension greater than or equal to 0.4 mm or even greater than or equal to 0.5 mm. In embodiments, the article may have at least one dimension from 0.4 mm to 0.8 mm, from 0.4 mm to 0.7 mm, from 0.4 mm to 0.6 mm, from 0.5 mm to 0.8 mm, from 0.5 mm to 0.7 mm, or even from 0.5 mm to 0.6 mm, or any and all sub-ranges formed from any of these endpoints.

The flame retardant in combination with the polycarbonate, the polysiloxane-polycarbonate copolymer, and the impact modifier, in the given amounts, imparts a thin-wall flammability rating to the polycarbonate-based composition of V-0.

The presence and amount of polysiloxane-polycarbonate copolymer imparts a melt flow rate to the polycarbonate-based composition greater than or equal to 15.0 g/10 min, as measured at a temperature of 300° C. and a load of 1.2 kg. In embodiments, the polycarbonate-based composition may comprise a melt flow rate from 15.0 g/10 min to 25.0 g/10 min, as measured at a temperature of 300° C. and a load of 1.2 kg. In embodiments, the polycarbonate-based composition may comprise a melt flow rate greater than or equal to 15.0 g/10 min, greater than or equal to 16.0 g/10 min, or even greater than or equal to 17.0 g/10 min, as measured at a temperature of 300° C. and a load of 1.2 kg. In embodiments, the polycarbonate-based composition may comprise a melt flow rate less than or equal to 25.0 g/10 min, less than or equal to 23.0 g/10 min, or even less than or equal to 20.0 g/10 min, as measured at a temperature of 300° C. and a load of 1.2 kg. In embodiments, the polycarbonate-based composition may comprise a melt flow rate from 15.0 g/10 min to 25.0 g/10 min, from 15.0 g/10 min to 23.0 g/10 min, from 15.0 g/10 min to 20.0 g/10 min, from 16.0 g/10 min to 25.0 g/10 min, from 16.0 g/10 min to 23.0 g/10 min, from 16.0 g/10 min to 20.0 g/10 min, from 17.0 g/10 min to 25.0 g/10 min, from 17.0 g/10 min to 23.0 g/10 min, or even from 17.0 g/10 min to 20.0 g/10 min, or any and all sub-ranges formed from any of these endpoints, as measured at a temperature of 300° C. and a load of 1.2 kg.

The presence and amount of the impact modifier impart a low temperature impact strength to the polycarbonate-based composition greater than or equal to 500 J/m. In embodiments, the polycarbonate-based composition may have a low temperature impact strength greater than or equal to 500 J/m, greater than or equal to 525 J/m, or even greater than or equal to 550 J/m.

The polycarbonate in combination with the polysiloxane-polycarbonate copolymer, the flame retardant, and the impact modifier, in the given amounts, imparts a laser transmission to the polycarbonate-based composition greater than or equal to 55%, as measured at a wavelength of 950 nm and an article thickness of 0.6 mm. In embodiments, the polycarbonate-based based composition has a laser transmission greater than or equal to 55%, greater than or equal to 57%, greater than or equal to 60%, or even greater than or equal to 63%, as measured at a wavelength of 950 nm and an article thickness of 0.6 mm.

In embodiments, the polycarbonate-based composition may have a tensile strength greater than or equal to 40 MPa, greater than or equal to 45 MPa, or even greater than or equal to 50 MPa. In embodiments, the polycarbonate-based composition may have a tensile strength less than or equal to 70 MPa, less than or equal to 65 MPa, or even less than or equal to 60 MPa. In embodiments, the polycarbonate-based composition may have a tensile strength from 40 MPa to 70 MPa, from 40 MPa to 65 MPa, from 40 MPa to 60 MPa, from 45 MPa to 70 MPa, from 45 MPa to 65 MPa, from 45 MPa to 60 MPa, from 50 MPa to 70 MPa, from 50 MPa to 65 MPa, or even from 50 MPa to 60 MPa, or any and all sub-ranges formed from any of these endpoints.

In embodiments, the polycarbonate-based composition may comprise a tensile modulus greater than or equal to 1500 MPa, greater than or equal to 1750 MPa, or even greater than or equal to 2000 MPa. In embodiments, the polycarbonate-based composition may comprise a tensile modulus less than or equal to 3000 MPa, less than or equal to 2750 MPa, or even less than or equal to 2500 MPa. In embodiments, the polycarbonate-based composition may comprise a tensile modulus from 1500 MPa to 3000 MPa, from 1500 MPa to 2750 MPa, from 1500 MPa to 2500 MPa, from 1750 MPa to 3000 MPa, from 1750 MPa to 2750 MPa, from 1750 MPa to 2500 MPa, from 2000 MPa to 3000 MPa, from 2000 MPa to 2750 MPa, or even from 2000 MPa to 2500 MPa, or any and all sub-ranges formed from any of these endpoints.

### Additives

In embodiments, the polycarbonate-based composition may further comprise at least one additive. In embodiments, the at least one additive may comprise antioxidants, ultraviolet light absorbers, lubricants, colorants, anti-dripping agents, plasticizers, anti-static agents, anti-hydrolysis agents, anti-microbial agents, or combinations thereof.

In embodiments, the amount of the at least one additive in the polycarbonate-based composition may be, based on a total weight of the polycarbonate-based composition, greater than or equal to 0.25 wt %, greater than or equal to 0.5 wt %, or even greater than or equal to 1 wt %. In embodiments, the amount of the at least one additive in the polycarbonate-based composition may be, based on a total weight of the polycarbonate-based composition, less than or equal to 5 wt %, less than or equal to 4 wt %, less than or equal to 3 wt %, or even less than or equal to 2 wt %. In embodiments, the amount of the at least one additive in the polycarbonate-based composition may be, based on a total weight of the polycarbonate-based composition, from 0.25 wt % to 5 wt %, from 0.25 wt % to 4 wt %, from 0.25 wt % to 3 wt %, from 0.25 wt % to 2 wt %, from 0.5 wt % to 5 wt %, from 0.5 wt % to 4 wt %, from 0.5 wt % to 3 wt %, from 0.5 wt % to 2 wt %, from 1 wt % to 5 wt %, from 1 wt % to 4 wt %, from 1 wt % to 3 wt %, or even from 1 wt % to 2 wt %, or any and all sub-ranges formed from any of these endpoints.

### Laser Welded Article

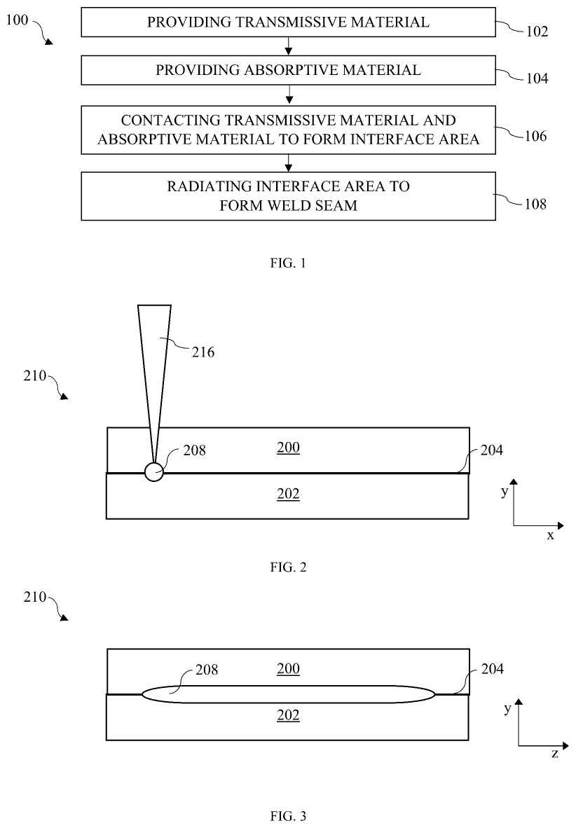

Referring now to FIGS. 1-3, a method of preparing a laser-welded article 100 begins at block 102 with providing a transmissive material 200. In embodiments, the transmissive material may comprise the polycarbonate-based composition, as described herein.

The method 100 continues at block 104 with providing an absorptive material 202. In embodiments, the absorptive material 202 may comprise a polymeric composition. In embodiments, the polymeric composition may comprise at least one polymer selected from polycarbonate, acrylonitrile-butadiene-styrene copolymer, polybutylene terephthalate, polyphenylene sulfite, styrene-acrylonitrile copolymer, thermal plastic elastomer, and their alloys.

The method 100 continues at block 106 with contacting the transmissive material 200 and the absorptive material 202 to form an interface area 204.

The method 100 continues at block 108 with radiating the interface area 204 by transmitting a laser beam 206 through the transmissive material 200, thereby fusing the transmissive material 200 to the absorptive material 202 at the interface area 204 to form a weld scam 208 and laser-welded article 210.

The transmissive material 200 is transmissive to the laser beam 206, meaning that the transmissive material 200 has a laser transmission greater than or equal to 55%, as measured at the wavelength of the laser beam 206 and an article thickness of 0.6 mm. The absorptive material 202 is capable of absorbing light from the laser beam 206, meaning that the absorptive material 202 has an absorbance of about 100%, as measured at the wavelength of the laser beam and an article thickness of 0.6 mm. By absorbing light from the laser beam 206, the absorptive material 202 converts light energy from the laser beam 206 to facilitate the fusing of the transmissive material 200 to the absorptive material 202 at the interface arca 204 to form the weld seam 208.

As shown in FIGS. 2 and 3, in embodiments, the transmissive material 200 may form a first portion of the laser-welded article 212 and the absorptive material 202 may form a second portion of the laser-welded article 212. Accordingly, in embodiments, the first portion of the laser-welded article 212 may comprise the polycarbonate-based composition described herein and the second portion of the laser-welded article 212 may comprise a polymeric composition. The first portion and the second portion are joined together at the weld seam 208.

### Processing

In embodiments, the polycarbonate-based composition described herein may be made with a batch process or continuous process.

In embodiments, the components of the polycarbonate-based composition, including the polycarbonate, the polysiloxane-polycabonate copolymer, the flame retardant, and the impact modifier, may be added to an extruder (26 MM Coperion Twin Extruder (L/D 44)) and blended. In embodiments, the blending (e.g., in the barrel of the extruder) may be carried out at a temperature from 150° C. to 280° C.

Blending (also known as compounding) devices are well known to those skilled in the art and generally include means of feeding, especially at least one hopper for pulverulent materials and/or at least one injection pump for liquid materials; high-shear blending means, for example a co-rotating or counter-rotating twin-screw extruder, usually comprising a feed screw placed in a heated barrel (or tube); an output head, which gives the extrudate its shape; and means for cooling the extrudate, either by air cooling or by circulation of water. The extrudate is generally in the form of rods continuously exiting the device and able to be cut or formed into granules. However, other forms may be obtained by fitting a die of desired shape on the output die.

### EXAMPLES

Table 1 below shows sources of ingredients used to form Comparative Compositions C1 to C13 and Example Compositions E1 and E2.

TABLE 1

| Ingredients | Brand | Source |
|---|---|---|
| polycarbonate | MAKROLON 2805 | Covestro |
| polycarbonate | MAKROLON 2405 | Covestro |
| polysiloxane-polycarbonate | TRIREX ST6-3022PJ(1) | Samyang |
| copolymer | | |
| flame retardant | HPCTP | Weihai Jinwei ChemIndustry Co., |
| (cyclic phenoxyphosphazene) | | Ltd. |
| flame retardant | PX220 | Zheijang Wangsheng Co., Ltd. |
| (phosphate ester) | | |
| impact modifier | METABLEN S 2030 | Mitsubishi Chemical Group |
| (silicone-acrylic) | | |
| impact modifier | PARALOID EXL-2330 | Dow |
| (butyl acrylate) | | |
| impact modifier | POLYLAC PA-757 | Chimei |
| (acrylonitrile butadiene styrene) | | |
| impact modifier | CLEAR STRENGTH E-920 | Arkema |
| (methylmethacrylate-butadiene- | | |
| styrene) | | |
| anti-dripping agent | POLYB FS-257 | Coating Products |
| lubricant | PETS | Lonza |
| anti-oxidant | IRGANOX 1076 | BASF |
| anti-oxidant | HOSTANOX P-EPQ | Clariant |
| UV light absorber | TINUVIN 360 ED | BASF |
| colorant | MACROLEX RED | Lanxess |
| colorant | MACROLEX GREEN | Lanxess |

Table 2 below shows the formulations (in wt %, based on a total weight of the polycarbonate-based composition) used to form and the certain properties of Comparative Compositions C1 to C13 and Example Compositions E1 and E2.

TABLE 2

| | C1 | C2 | C3 | C4 | C5 |
|---|---|---|---|---|---|
| MAKROLON 2805 | 94.95 | 29.95 | 0 | 0 | 0 |
| MAKROLON 2405 | 0 | 0 | 29.95 | 23.45 | 29.95 |
| TRIREX ST6-3022PJ(1) | 0 | 65.00 | 65.00 | 65.00 | 65.00 |
| HPCTP | 3.50 | 3.50 | 3.50 | 10.00 | 0 |
| PX220 | 0 | 0 | 0 | 0 | 3.50 |
| METABLEN S 2030 | 0 | 0 | 0 | 0 | 0 |
| PARALOID EXL-2330 | 0 | 0 | 0 | 0 | 0 |
| POLYLAC PA-757 | 0 | 0 | 0 | 0 | 0 |
| CLEAR STRENGTH E-920 | 0 | 0 | 0 | 0 | 0 |
| POLYB FS-257 | 0.50 | 0.50 | 0.50 | 0.50 | 0.50 |
| PETS | 0.20 | 0.20 | 0.20 | 0.20 | 0.20 |
| IRGANOX 1076 | 0.10 | 0.10 | 0.10 | 0.10 | 0.10 |
| HOSTANOX P-EPQ | 0.15 | 0.15 | 0.15 | 0.15 | 0.15 |
| TINUVIN 360 ED | 0.30 | 0.30 | 0.30 | 0.30 | 0.30 |
| MACROLEX RED | 0.10 | 0.10 | 0.10 | 0.10 | 0.10 |
| MACROLEX GREEN | 0.20 | 0.20 | 0.20 | 0.20 | 0.20 |
| TOTAL | 100.00 | 100.00 | 100.00 | 100.00 | 100.00 |
| Thin-wall flammability rating | V-2 | V-1 | V-2 | V-2 | V-1 |
| Melt flow rate (g/10 min) | 13.9 | 8.3 | 8.8 | 17.2 | 11.4 |
| Low temperature impact strength (J/m) | 66 | 366 | 423 | 95 | 275 |
| Transmission (%) | 73 | 80 | 79 | 80 | 78 |
| Tensile strength (MPa) | 64.0 | 58.7 | 58.6 | 56.6 | 61.3 |
| Tensile modulus (MPa) | 2308 | 2128 | 2108 | 2187 | 2224 |
| | C6 | C7 | C8 | C9 | C10 |
| MAKROLON 2805 | 0 | 0 | 0 | 0 | 0 |
| MAKROLON 2405 | 23.45 | 22.95 | 21.95 | 53.45 | 53.45 |
| TRIREX ST6-3022PJ(1) | 65.00 | 65.00 | 65.00 | 25.00 | 25.00 |
| HPCTP | 0 | 10.00 | 10.00 | 10.00 | 10.00 |
| PX220 | 10.00 | 0 | 0 | 0 | 0 |
| METABLEN S 2030 | 0 | 0 | 0 | 0 | 0 |
| PARALOID EXL-2330 | 0 | 0.50 | 1.50 | 10.00 | 0 |
| POLYLAC PA-757 | 0 | 0 | 0 | 0 | 10.00 |
| CLEAR STRENGTH E-920 | 0 | 0 | 0 | 0 | 0 |
| POLYB FS-257 | 0.50 | 0.50 | 0.50 | 0.50 | 0.50 |
| PETS | 0.20 | 0.20 | 0.20 | 0.20 | 0.20 |
| IRGANOX 1076 | 0.10 | 0.10 | 0.10 | 0.10 | 0.10 |
| HOSTANOX P-EPQ | 0.15 | 0.15 | 0.15 | 0.15 | 0.15 |
| TINUVIN 360 ED | 0.30 | 0.30 | 0.30 | 0.30 | 0.30 |
| MACROLEX RED | 0.10 | 0.10 | 0.10 | 0.10 | 0.10 |
| MACROLEX GREEN | 0.20 | 0.20 | 0.20 | 0.20 | 0.20 |
| TOTAL | 100.00 | 100.00 | 100.00 | 100.00 | 100.00 |
| Thin-wall flammability rating | V-2 | V-2 | V-2 | V-2 | V-2 |
| Melt flow rate (g/10 min) | 18.4 | 15.0 | 16.1 | 18.8 | 42.8 |
| Low temperature impact strength (J/m) | 56 | 489 | 694 | 572 | 44 |
| Transmission (%) | 80 | 70 | 60 | 42 | 76 |
| Tensile strength (MPa) | 64.0 | 55.5 | 53.5 | 45.8 | 58.6 |
| Tensile modulus (MPa) | 2393 | 2150 | 2112 | 1924 | 2305 |
| | C11 | C12 | C13 | E1 | E2 |
| MAKROLON 2805 | 0 | 0 | 0 | 0 | 0 |
| MAKROLON 2405 | 53.45 | 53.45 | 22.95 | 22.45 | 21.95 |
| TRIREX ST6-3022PJ(1) | 25.00 | 25.00 | 65.00 | 65.00 | 65.00 |
| HPCTP | 10.00 | 10.00 | 10.00 | 10.00 | 10.00 |
| PX220 | 0 | 0 | 0 | 0 | 0 |
| METABLEN S 2030 | 0 | 10.00 | 0.50 | 1.00 | 1.50 |
| PARALOID EXL-2330 | 0 | 0 | 0 | 0 | 0 |
| POLYLAC PA-757 | 0 | 0 | 0 | 0 | 0 |
| CLEAR STRENGTH E-920 | 10.00 | 0 | 0 | 0 | 0 |
| POLYB FS-257 | 0.50 | 0.50 | 0.50 | 0.50 | 0.50 |
| PETS | 0.20 | 0.20 | 0.20 | 0.20 | 0.20 |
| IRGANOX 1076 | 0.10 | 0.10 | 0.10 | 0.10 | 0.10 |
| HOSTANOX P-EPQ | 0.15 | 0.15 | 0.15 | 0.15 | 0.15 |
| TINUVIN 360 ED | 0.30 | 0.30 | 0.30 | 0.30 | 0.30 |
| MACROLEX RED | 0.10 | 0.10 | 0.10 | 0.10 | 0.10 |
| MACROLEX GREEN | 0.20 | 0.20 | 0.20 | 0.20 | 0.20 |
| TOTAL | 100.00 | 100.00 | 100.00 | 100.00 | 100.00 |
| Thin-wall flammability rating | V-2 | V-2 | V-2 | V-0 | V-0 |
| Melt flow rate (g/10 min) | 14.7 | 17.9 | 16.7 | 18.1 | 17.4 |
| Low temperature impact strength (J/m) | 320 | 593 | 383 | 528 | 559 |
| Transmission (%) | 57 | 44 | 69 | 64 | 63 |
| Tensile Strength (MPa) | 47.1 | 46.2 | 55.7 | 55.0 | 54.3 |
| Tensile Modulus (MPa) | 1947 | 1912 | 2159 | 2110 | 2160 |

Comparative Composition C1: Compositions including polycarbonate and cyclic phenozyphosphazene flame retardant—Comparative Composition C1, a composition including MAKROLON 2805 (polycarbonate) and HPCTP (cyclic phenoxyphosphazene flame retardant), did not have a sufficient thin-wall flammability rating, melt flow rate, and low temperature impact strength. As exemplified by Comparative Composition C1, a polycarbonate composition may have sufficient transmission, but lack sufficient thin-wall flammability rating, melt flow rate, and low temperature impact strength.

Comparative Composition C2-C6: Compositions including polycarbonate, polysiloxane-polycarbonate colpolymer, and cyclic phenoxyphosphazene or phosphate ester flame retardant—Comparative Compositions C2, C3, and C5 compositions including MAKROLON 2805 or MAKROLON 2405 (polycarbonate), TRIREX ST6-3022PJ(1) (polysiloxane-polycarbonate copolymer), and 3.50 wt % HPCTP (cyclic phenoxyphosphazene flame retardant) or PX220 (phosphate ester flame retardant), did not have a sufficient thin-wall flammability rating, melt flow rate, and low temperature impact strength. Comparative Compositions C4 and C6, compositions including MAKROLON 2405, TRIREX ST6-3022PJ(1), and 10.00 wt % HPCTP or PX220, did not have a sufficient thin-wall flammability rating and low temperature impact strength. As exemplified by Comparative Compositions C1-C6, simply increasing the amount of flame retardant may not achieve a sufficient thin-wall flammability rating, among other desired properties.

Comparative Compositions C7-C11: Compositions including polycarbonate, polysiloxane-polycarbonate copolymer, cyclic phenoxyphosphazene flame retardant, and butyl acrylate, acrylonitrile butadiene styrene, or methylmethacrylate-butadiene styrene impact modifier—Comparative Composition C7, a composition including MAKROLON 2405 (polycarbonate), TRIREX ST6-3022PJ(1) (polysiloxane-polycarbonate copolymer), HPCTP (cyclic phenoxyphosphazene flame retardant), and 0.50 wt % PARALOID EXL-2330 (butyl acrylate impact modifier), did not have a sufficient thin-wall flammability rating and low temperature impact strength. Comparative Composition C8, a composition including MAKROLON 2405, TRIREX ST6-3022PJ (1), HPCTP, and 1.50 wt % PARALOID EXL-2330, did not have a sufficient thin-wall flammability rating. Comparative Composition C9, a composition including MAKROLON 2405, TRIREX ST6-3022PJ(1), HPCTP, and 10.00 wt % POLYLAC PA-757 (acrylonitrile butadiene styrene impact modifier), did not have a sufficient thin-wall flammability rating and transmission. Comparative Composition C10, a composition including MAKROLON 2405, TRIREX ST6-3022PJ (1), HPCTP, and 10.00 wt % POLYLAC PA-757, did not have a sufficient thin-wall flammability rating and low temperature impact strength. Comparative Composition C11, a composition including MAKROLON 2405, TRIREX ST6-3022PJ(1), HPCTP, and 10.00 CLEAR STRENGTH E-920 (methylmethacrylate-butadiene-styrene impact modifier), did not have a sufficient thin-wall flammability rating, melt flow rate, and low temperature impact strength. As exemplified by Comparative Compositions C7-C11, increasing the amount of impact modifier may not achieve a sufficient low temperature impact strength, among other desired properties.

Comparative Compositions C12 and C13 and Example Compositions E1 and E2: Compositions including polycarbonate, polysiloxane-polycarbonate copolymer, cyclic phenoxyphosphazene flame retardant, and silicone-acrylic impact modifier—Comparative Example C12, a composition including 53.45 wt % MAKROLON 2405 (polycarbonate), 25.00 wt % TRIREX ST6-3022PJ(1) (polysiloxane-polycarbonate copolymer), HPCTP (cyclic phenoxyphosphazene flame retardant), and 10 wt % METABLEN S 2030 (silicone-acrylic impact modifier), did not have a sufficient thin-wall flammability rating and transmission. Comparative Example C12, a composition including 22.95 wt % MAKROLON 2405, 65.00 wt % TRIREX ST6-3022PJ(1), HPCTP, and 0.5 wt % METABLEN S 2030, did not have a sufficient thin-wall flammability rating and low temperature impact strength. Example Compositions E1 and E2, compositions including 22.45 wt % and 21.95 wt % MAKROLON 2405, 65.00 wt % TRIREX ST6-3022PJ (1), HPCTP, and 1.0 wt % and 1.5 wt % METABLEN S 2030, had a sufficient thin-wall flammability rating, melt flow rate, low temperature impact strength, and transmission. As exemplified by Comparative Compositions C12 and C13 and Example Compositions E1 and E2, a combination of polycarbonate, polysiloxane-polycarbonate copolymer, the flame retardant, and the impact modifier, present in given amounts, as described herein, results in sufficient thin-wall flammability rating, melt flow rate, low temperature impact strength, and transmission.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

1. A polycarbonate-based composition comprising, based on a total weight of the polycarbonate-based composition:

2. The polycarbonate-based composition of claim 1, wherein the flame retardant is a cyclic phenoxyphosphazene.

3. The polycarbonate-based composition of claim 1, wherein the impact modifier is a core-shell particle having a core comprising silicone-acrylate rubber and a shell comprising methyl methacrylate.

4. The polycarbonate-based composition of claim 1, wherein the impact modifier is a core-shell particle having a D50 particle size from 200 nm to 800 nm.

5. The polycarbonate-based composition of claim 1, wherein the polycarbonate has a weight-average molecular weight from about 20,000 g/mol to about 30,000 g/mol.

6. The polycarbonate-based composition of claim 1, wherein the polysiloxane-polycarbonate copolymer has a weight-average molecular weight from about 20,000 g/mol to about 40,000 g/mol.

7. The polycarbonate-based composition of claim 1, wherein the polycarbonate-based composition is in the form of an article, the article having at least one dimension from 0.4 mm to 0.8 mm.

8. The polycarbonate-based composition of claim 1, wherein the polycarbonate-based composition is in the form of an article, the article having at least one dimension that is less than 0.6 mm.

9. The polycarbonate-based composition of claim 1, wherein the polycarbonate-based composition includes at last one additive, the at least one additive comprising antioxidants, ultraviolet light absorbers, lubricants, colorants, anti-dripping agents, plasticizers, anti-static agents, anti-hydrolysis agents, anti-microbial agents, or combinations thereof.

10. The polycarbonate-based composition of claim 1, wherein the polycarbonate-based composition has a laser transmission greater than or equal to 55%, as measured at a wavelength of 800 nm to 1100 nm and an article thickness of 0.6 mm.

11. The polycarbonate-based composition of claim 1, wherein the polycarbonate-based composition has a melt flow rate greater than or equal to 15.0 g/10 min, as measured according to ASTM D1238-20 at a temperature of 300• and a load of 1.2 kg.

12. The polycarbonate-based composition of claim 11, wherein the polycarbonate-based composition has a melt flow rate from 15.0 g/10 min to 25.0 g/10 min, as measured according ASTM D1238-20 at a temperature of 300. and a load of 1.2 kg.

13. The polycarbonate-based composition of any of the preceding claim 1, wherein the polycarbonate-based composition has a thin-wall flammability rating of V-0, as measured according to UL 94 at article dimensions of 127 mm×12.7 mm×0.6 mm.

14. The polycarbonate-based composition of claim 1, wherein the polycarbonate-based composition has a low temperature impact strength greater than or equal to 500 J/m, as measured according to ASTM D256-10 at −25.• and 5.5 J and at article dimensions of 63.5 mm×12.7 mm×3.2 mm.

15. A method of preparing a laser-welded article comprising:
providing a transmissive material comprising the polycarbonate-based composition of claim 1;
providing an absorptive material comprising a polymeric composition;
contacting the transmissive material and the absorptive material to form an interface area; and
radiating the interface area by transmitting a laser beam through the transmissive material, thereby fusing the transmissive material to the absorptive material at the interface area to form a weld seam, wherein the transmissive material is transmissive to the laser beam and the absorptive material is capable of absorbing light from the laser beam, thereby converting light energy from the laser beam into heat energy to facilitate the fusing of the transmissive material to the absorptive material at the interface area to form the weld seam.

16. The method of claim 15, where in the polymeric composition comprises at least one polymer selected from polycarbonate, acrylonitrile-butadiene-styrene copolymer, polybutylene terephthalate, polyphenylene sulfite, styrene-acrylonitrile copolymer, thermal plastic elastomer, and their alloys.

17. A laser-welded article comprising:
a first portion comprising the polycarbonate-based based composition of claim 1, and
a second portion comprising a polymeric composition,
wherein the first portion and the second portion are joined together at a weld seam.
